(19) United States
(12) Patent Application Publication
(10) Pub. No.: US 2012/0058383 A1
(43) Pub. Date: Mar. 8, 2012

(54) ASSEMBLED BATTERY

(75) Inventor: Katsuo Hashizaki, Tokyo (JP)

(73) Assignee: MITSUBISHI HEAVY INDUSTRIES, LTD., Tokyo (JP)

(21) Appl. No.: 13/222,749

(22) Filed: Aug. 31, 2011

(30) Foreign Application Priority Data
Sep. 3, 2010 (JP) 2010-198150

(51) Int. Cl. H01M 2/24

(52) U.S. Cl. 429/158

(57) ABSTRACT

An assembled battery includes: a plurality of electrical cells that includes a battery body and an electrode terminal protruding from the battery body; and a terminal connection member that connects a pair of electrode terminals between two of the plurality of electrical cells, wherein the terminal connection member includes: a pair of electrode sockets each allowing the electrode terminal to be inserted thereinto, and a conductor electrically connecting the pair of electrode sockets to each other, and wherein each electrode socket includes: an opposite conductive wall extending from the conductor along the electrode terminal and facing the electrode terminal, and an elastic portion provided at a position facing the opposite conductive wall toward the electrode terminal and pressing the electrode terminal to the opposite conductive wall.

### BACKGROUND OF THE INVENTION

1. Field of the Invention

The present invention relates to an assembled battery.

Priority is claimed on Japanese Patent Application No. 2010-198150, filed on Sep. 3, 2010, the content of which is incorporated herein by reference.

2. Description of Related Art

It is widely known that a rechargeable secondary battery has been used in fields such as an electrical vehicle, a power storage system, and an uninterruptible power system (UPS). In the exemplified field, since the power supply capacity is several ten thousand Wh, an assembled battery is generally used in which a plurality of electrical cells is connected in series or in parallel to each other.

In such an assembled battery, for example, a positive electrode terminal of an electrical cell, and a negative electrode terminal of an electrical cell located right next to the electrical cell having the positive electrode terminal, are connected to each other through a terminal connection member configured as a conductor (for example, copper or the like). As a general connection method, the electrode terminals are connected to each other in a manner such that the terminal connection member is disposed across electrode terminals and bolts are threaded into female screws respectively provided in the electrode terminals to be fastened thereto (refer to Japanese Patent Application Laid-Open No. 9-219186).

When the terminal connection member is fixed by bolts as in the related art, the bolts are loosened due to the environment in which it is used or repeated charging and discharging operations. For this reason, there is concern in that the electrical resistance (contact resistance) of the contact portion between the electrode terminal and the terminal connection member may increase.

In Japanese Patent Application Laid-Open No. 2004-327310, a clip portion is formed at each of both ends of the terminal connection member so as to nip the electrode terminal, and the terminal connection member and the electrode terminal are both soldered in advance. Then, each electrode terminal is connected to the clip portion, and each electrode terminal and each clip portion are connected to each other by metal bonding. Accordingly, electrical corrosion may be prevented and the electrode terminals may be easily and reliably connected to each other.

However, in the related art, since it takes time and effort in the work of attachment and detachment of the connections for each electrode terminal and each clip portion through metal bonding, there is a possibility that when there is a failure, maintenance or the like is difficult.

### SUMMARY OF THE INVENTION

The invention is made in view of the above-described problems, and it is an object of the invention to reduce contact resistance and make attachment and detachment easier.

According to an aspect of the invention, there is provided an assembled battery including: a plurality of electrical cells that includes a battery body and an electrode terminal protruding from the battery body; and a terminal connection member that connects a pair of electrode terminals between two of the plurality of electrical cells. The terminal connection member includes: a pair of electrode sockets each allowing the electrode terminal to be inserted thereinto, and a conductor electrically connecting the pair of electrode sockets to each other. Each electrode socket includes: an opposite conductive wall extending from the conductor along the electrode terminal and facing the electrode terminal, and an elastic portion provided at a position facing the opposite conductive wall through the electrode terminal and pressing the electrode terminal to be restrained by the opposite conductive wall.

With this configuration, since the elastic portion is provided to press the electrode terminal to the opposite conductive wall, the electrode terminal and the opposite conductive wall may be adhered to each other through a pressing of the elastic portion, and contact resistance may be reduced. Further, since the electrode terminal and the opposite conductive wall are restrained or released depending on the pressing of the elastic portion, the terminal connection member and the electrode terminal may be easily attached to or detached from each other.

Therefore, it is possible to keep the low contact resistance and make attachment and detachment easier.

Further, the terminal connection member may include an insulating portion that coats at least a part of an outer surface of the conductor and the opposite conductive wall. Accordingly, it is possible to suppress short-circuiting caused by the contact of foreign matter.

Further, the elastic portion may be formed as a member separated from the opposite conductive wall. Accordingly, it is possible to minutely and easily adjust the pressing force by changing the elastic portion.

Further, the electrode terminal may be formed in a flat plate shape and has a first hollow formed on the plate surface thereof, and the terminal connection member may include a spherical body provided at the front end of the elastic portion and fitted to the first hollow. Accordingly, the electrode terminal and the terminal connection member are locked to each other by the fitting between the first hollow and the spherical body, so that the electrode terminal and the terminal connection member may be further reliably prevented from being separated from each other.

Further, the electrode socket may be divided into two parts in a direction intersecting the protruding direction of the electrode terminal, one of two parts may include the opposite conductive wall, and the other of two parts may be formed to have elasticity and serves as the elastic portion. Accordingly, since the structure becomes simple, it is possible to decrease the weight or improve the maintenance workability.

Further, the electrode terminal may be formed in a cylindrical shape and have a circumferential groove formed at the outer peripheral surface thereof, and the terminal connection member may include a claw portion protruding from each of the electrode sockets and fitted to this groove. Accordingly, the electrode terminal and the terminal connection member are locked to each other by the fitting between the groove and the claw portion, so that the electrode terminal and the terminal connection member may be further reliably prevented from being separated from each other.

According to the assembled battery of the aspect of the invention, it is possible to keep the low contact resistance and make attachment and detachment easier.

### BRIEF DESCRIPTION OF THE DRAWINGS

FIG. 1 is a perspective view illustrating a main part of an assembled battery according to a first embodiment of the invention.

FIG. 2 is a cross-sectional view taken along the line S1-S1 of FIG. 1.

FIG. 3 is a cross-sectional view taken along the line S2-S2 of FIG. 1.

FIG. 4 is a cross-sectional view taken along the line S3-S3 of FIG. 3.

FIG. 5 is a cross-sectional view illustrating an assembly configuration of an electrode terminal 12 and a terminal connection member 20 according to a battery system of the first embodiment of the invention.

FIG. 6 is a perspective view illustrating a main part of an assembled battery according to a second embodiment of the invention.

FIG. 7 is a cross-sectional view taken along the line S4-S4 of FIG. 6.

FIG. 8 is a cross-sectional view taken along the line S5-s5 of FIG. 7.

### DETAILED DESCRIPTION OF THE INVENTION

Hereinafter, exemplary embodiments of the invention will be described by referring to the accompanying drawings.

### First Embodiment

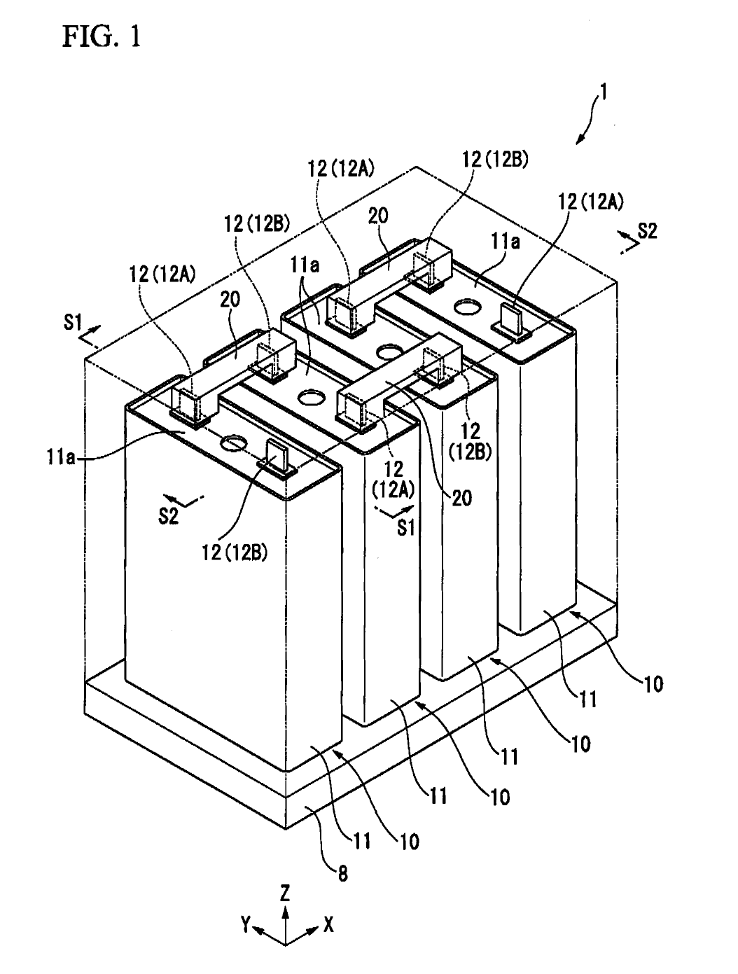

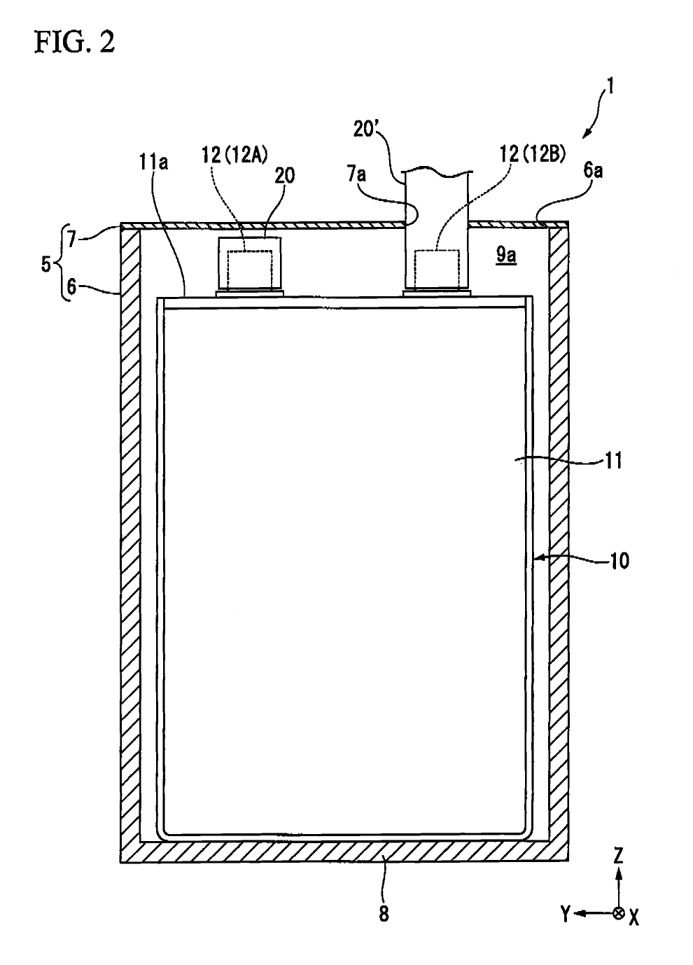

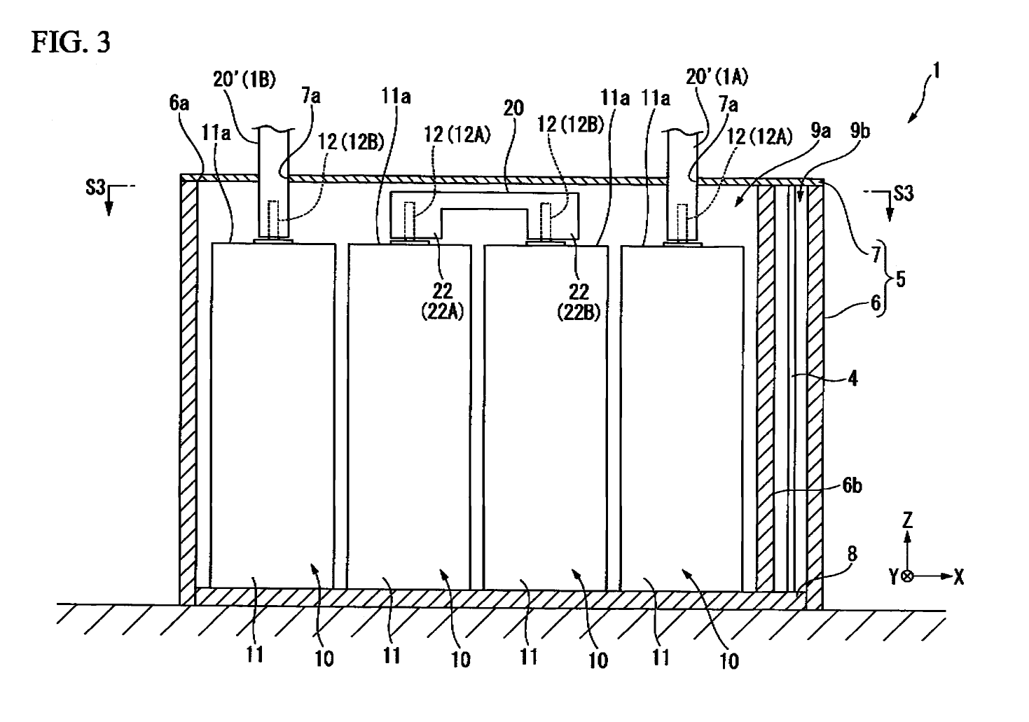

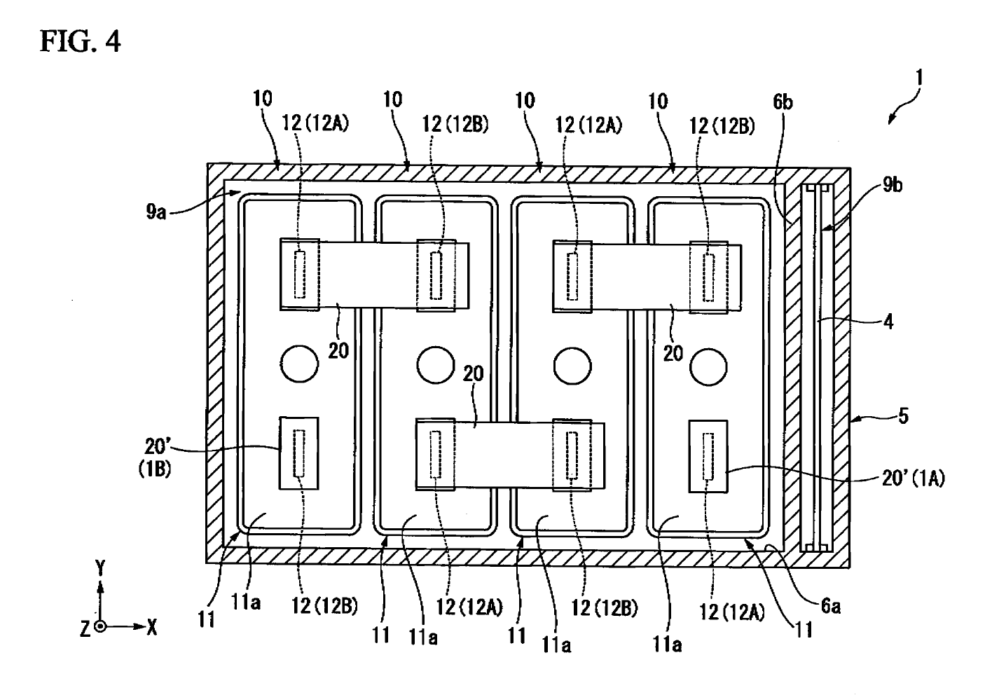

FIG. 1 is a perspective view illustrating an assembled battery 1 according to a first embodiment of the invention, FIG. 2 is a cross-sectional view taken along the line S1-S1 of FIG. 1, FIG. 3 is a cross-sectional view taken along the line S2-S2 of FIG. 1, and FIG. 4 is a cross-sectional view taken along the line S3-S3 of FIG. 3.

As shown in FIG. 1, the assembled battery 1 includes a plurality of electrical cells 10 that are chargeable/dischargeable. It means that they are secondary batteries. The assembled battery 1 is used as a power supply of a battery system, for example, a power supply driving a mobile object such as a deep-sea research vehicle or an electrical vehicle or a power supply provided in a stationary device such as a power storage device or a UPS device.

Furthermore, in the description below, the longitudinal direction of the assembled battery 1 is set as the X direction, the lateral direction of the assembled battery 1 is set as the Y direction, and the height direction of the assembled battery 1 is set as the Z direction.

As shown in FIGS. 3 and 4, the assembled battery 1 schematically includes: the plurality of electrical cells 10; a control unit 4 that controls the electrical cells 10; and a container 5 that receives the electrical cells 10 and the control unit 4.

As shown in FIG. 2, the container 5 includes: a lower casing 6 that receives the electrical cells 10 and the control unit 4, is formed like a parallelepiped shape having a bottom, and has an opening 6a; and an upper casing 7 that is a cover opening and closing the opening 6a of the lower casing 6. The lower casing 6 and the upper casing 7 are all formed of, for example, an insulator such as a synthetic resin.

As shown in FIG. 4, a bottom wall portion 8, as the bottom, of the lower casing 6 is formed in a rectangular shape in the plan view.

The lower casing 6 is provided with a partition wall 6b that divides the inside of the lower casing 6 into two parts in the X direction, an electrical cell chamber 9a that receives the plurality of electrical cells 10, and a control unit chamber 9b that receives the control unit 4.

As shown in FIG. 1, the electrical cell 10 is, for example, a battery such as a lithium-ion secondary battery formed in a parallelepiped shape. As shown in FIGS. 3 and 4, the electrical cells 10 are arranged on the bottom wall portion 8 inside the electrical cell chamber 9a at the same interval in the X direction. Furthermore, in FIG. 1, the other members (the portions other than the bottom wall portion 8 in the lower casing 6) of the container 5 are not shown in the drawings.

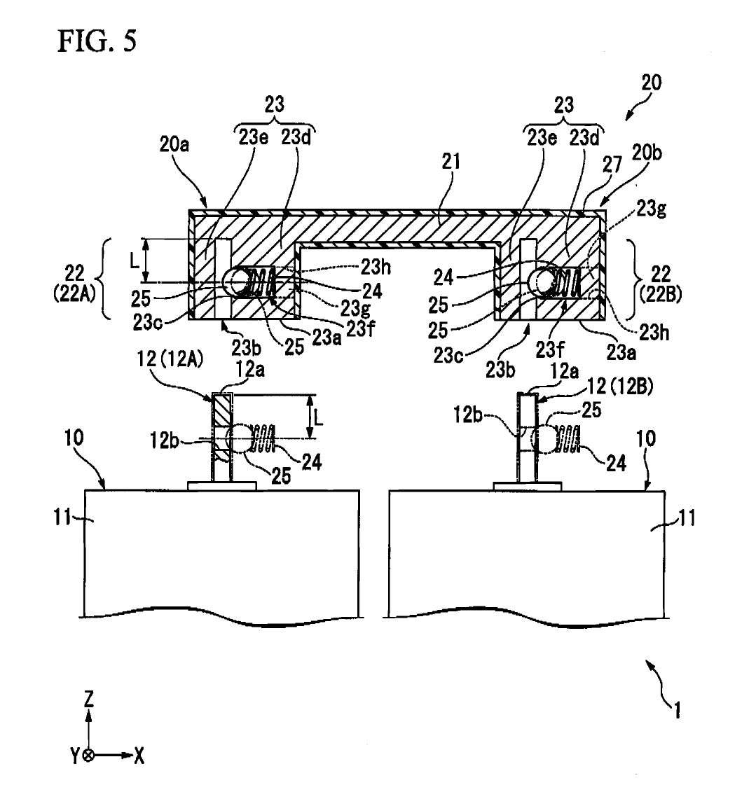

As shown in FIG. 2, the electrical cell 10 includes: a battery body 11 that is formed in a parallelepiped shape and two electrode terminals 12 that protrude in the +Z direction from a top surface 11a of the battery body 11. As shown in FIG. 1, the electrode terminal 12 is formed in a flat plate shape. The flat surface of the electrode terminal 12 is directed to the X direction. One electrode terminal 12 is set as a positive electrode 12A, and the other electrode terminal 12 is set as a negative electrode 12B, in the electrical cell 10. A through hole (a first hollow) 12b is formed at the flat surface of each of the electrode terminals 12 (12A and 12B). There is a distance L from the front end 12a to the center of the through hole in the +Z direction (refer to FIG. 5).

As shown in FIG. 4, the plurality of electrical cells 10 is arranged so that respective positions of the positive electrode 12A and the negative electrode 12B of the electrode terminal 12 are alternated in the X direction. Then, the electrode terminals 12 of the electrical cells 10 are electrically connected in series to each other through a block-shaped terminal connection member 20. The terminal connection member 20 will be described in detail later.

As shown in FIG. 4, in the electrical cells 10 arranged at both ends in the X direction of the plurality of electrical cells 10, the electrode terminal 12 not connected to the adjacent electrical cell 10 is connected to one end of a terminal connection member 20′. As shown in FIG. 3, the other end of the terminal connection member 20′ is exposed to the outside through an insertion hole 7a formed in the upper casing 7 of the container 5, and each of them serves as a positive electrode 1A or a negative electrode 1B of the assembled battery 1 (not shown in FIG. 1).

As shown in FIG. 4, the control unit 4 is, for example, a control circuit formed on a substrate, and is put in the control unit chamber 9b. The control unit 4 is, for example, a CMU, and is configured to measure and acquire a parameter value such as a voltage value from the electrical cell 10 (in FIG. 4, the control unit 4 is connected to four electrical cells 10) connected thereto and transmit the acquired parameter value to a BMU (Battery Management Unit) (the CMU or the BMU is also referred to as a measurement unit).

FIG. 5 is a cross-sectional view illustrating an assembly configuration of the electrical cell 10 and the terminal connection member 20.

As described above, the terminal connection member 20 connects the pair of electrode terminals 12 (12A and 12B) between two electrical cells 10 adjacent to each other in the X direction. The pair of electrode terminals 12 includes the positive electrode 12A and the negative electrode 12B which is a pair of two electrical cells 10 connecting in series to each other.

As shown in FIG. 5, the terminal connection member 20 includes a conductor 21, a pair of electrode sockets 22 (22A and 22B), and an insulating portion 27.

As shown in FIG. 5, the conductor 21 is formed of a conductive material such as copper, extends in the X direction, and the dimension in the X direction is set to be longer than the distance between the pair of electrode terminals 12 (12A and 12B). The conductor 21 is coated with the insulating portion 27, which is formed of an insulating resin.

As shown in FIG. 5, the pair of electrode sockets 22 (22A and 22B) protrudes in a parallelepiped shape in the −Z direction from both ends 20a and 20b of the terminal connection member 20 (refer to FIGS. 1 and 3).

Each electrode socket 22 (22A and 22B) includes a conductive block 23 that is integrally formed with the conductor 21 and protrudes in a rectangular parallelepiped shape in the −Z direction from the conductor 21, an elastic portion 24 that is formed of an elastic body, and a spherical body 25 that is provided at the front end of the elastic portion 24.

In the conductive block 23, a lower surface 23a directed toward the −Z direction is provided with an insertion hole 23b allowing the electrode terminal 12 to be inserted thereinto.

The cross-section of the insertion hole 23b is formed in a rectangular shape so that the size is substantially equal to the size of the cross-section intersecting the Z direction of the electrode terminal 12, and the insertion hole is perforated in the +Z direction so as to be slightly shorter than the length of the electrode terminal 12 (12A and 12B) in the Z direction.

The insertion hole 23b is positioned to the −X direction from the center of the lower surface 23a. For this reason, as shown in FIG. 5, the conductive block 23 includes an elastic body receiving portion 23d, that is formed to be thicker in the +X direction and receives the elastic portion 24, and the spherical body 25, and an opposite conductive wall 23e, that is formed to be thinner in the −X direction and faces the elastic body receiving portion 23d.

In the elastic body receiving portion 23d, a bottomed cylindrical hole 23f, perforated to the +X direction, is formed at a position apart from the ceiling end of the insertion hole 23b by a distance L in the Z direction. The opening end 23c of the bottomed cylindrical hole 23f is narrowed, and the diameter is decreased as compared with the other parts of the bottomed cylindrical hole 23f.

The opposite conductive wall 23e extends downward from the conductor 21, and faces the elastic body receiving portion 23d through the insertion hole 23b.

Specifically, the elastic portion 24 is configured as a coil spring, and is inserted in the bottomed cylindrical hole 23f.

The base end of the elastic portion 24 is fixed to the bottom portion of the bottomed cylindrical hole 23f, and the elastic portion may be expanded and contracted in the X direction inside the bottomed cylindrical hole 23f.

The spherical body 25 is formed of a conductive material such as copper, is connected to the front end of the elastic portion 24, and is positioned in the bottomed cylindrical hole 23f. The diameter of the spherical body 25 is set to be slightly smaller than the inner diameter of the bottomed cylindrical hole 23f, and is set to be larger than the diameter of the opening end 23c. That is, as shown in FIG. 5, the spherical body 25 adheres to the opening end 23c in the case that the terminal connection member 20 and the electrical cell 10 are separated from each other. At this time, a substantially half portion of the spherical body 25 is exposed from the opening end 23c.

Furthermore, as shown in FIG. 5, in the embodiment, the spherical body 25 adheres to the opening end 23C without any contact to the opposite surface of the insertion hole 23b. However, the spherical body 25 may come into contact with the opposite surface of the insertion hole 23b.

In such a state, the spherical body 25 is pushed to the −X direction by the elastic portion 24, the movement to the −X direction is stopped by the opening end 23c (the spherical body 25 depicted by the solid line in FIG. 5), and it is permitted that the spherical body 25 is able to move to the +X direction (depicted by the two-dotted chain line to overlap a part of the spherical body 25 depicted by the solid line in FIG. 5).

For example, a portion corresponding to the bottom portion of the bottomed cylindrical hole 23f is formed as a splittable cover 23g, and the base end of the elastic portion 24 is fixed to the cover 23g. Further, screw portions are respectively formed in the outer periphery of the cover 23g and the outer periphery 23h of the end of the bottomed cylindrical hole 23f. So screwing and connecting to each other, the elastic body receiving portion 23d is formed.

An insulating portion 27 is formed of an insulating resin, and coated to surface of the conductor 21 and the conductive block 23, except for the lower surface 23a of the conductive block 23.

Next, the mounting process of the terminal connection member 20 with the above-described configuration will be described.

First, the electrical cell 10 and the terminal connection member 20 are separated from each other. Then, when the terminal connection member 20 is attached to the electrode terminal 12, the pair of electrode terminals 12 (12A and 12B) is respectively inserted into the insertion holes 23b of the pair of electrode sockets 22 (22A and 22B).

Subsequently, each electrode terminal 12 is pressed into each insertion hole 23b. After the front end 12a of the electrode terminal 12 comes into contact with the spherical body 25, the spherical body 25 is displaced to be pressed and retracted to the +X direction (refer to the electrode socket 22 in FIG. 5). Then, after the electrode terminal 12 slides on the spherical body 25, the front end 12a of the electrode terminal 12 reaches the bottom portion of the insertion hole 23b.

When the front end 12a of the electrode terminal 12 comes into contact with the bottom portion of the insertion hole 23b, the through hole 12b of the electrode terminal 12 and the bottomed cylindrical hole 23f are located at the substantially same position in the Z direction, and the spherical body 25 protruding from the opening end 23c is fitted into the through hole 12b.

In this state, the electrode terminal 12 is pressed from the elastic portion 24 in the −X direction through the spherical body 25. By this pressing, the opposite conductive wall 23e and the electrode terminal 12 adhere to each other, so that the friction between them increases. Therefore, the electrode terminal 12 is difficult to move from the opposite conductive wall 23e.

Furthermore, because the spherical body 25 and the through hole 12b are fitted to each other, the opposite conductive wall 23e is locked to the electrode terminal 12. As a result, the wall is not easily displaced in the Z direction and the electrical cell 10 and the electrode connection member 20 are not easily separated from each other.

In this manner, the terminal connection member 20 is attached to the electrical cell 10.

On the other hand, when the electrical cell 10 and the terminal connection member 20 are separated from each other in a case of a maintenance or the like, the electrical cell 10 and the terminal connection member 20 are displaced in the Z direction to be separated from each other against the frictional resistance. In this manner, the spherical body 25 is displaced to the +X direction and the fitting between the spherical body 25 and the through hole 12b is released. Therefore, they are separated from each other.

Furthermore, when the electrical cell 10 and the terminal connection member 20 are relatively displaced in the Z direction against the frictional resistance, the electrode terminal 12 and the opposite conductive wall 23e are released. Therefore, they are separated from each other.

As described above, according to the terminal connection member 20, since the elastic portion 24 is provided to press the electrode terminal 12 for the opposite conductive wall 23e to contact with the electrode terminal 12, the electrode terminal 12 and the opposite conductive wall 23e are adhered strongly to each other due to the pressing of the elastic portion 24. Therefore, contact resistance is kept lower. Further, since the electrode terminal 12 and the opposite conductive wall 23e are restrained or released depending on the pressing of the elastic portion 24, the terminal connection member 20 and the electrode terminal 12 may be easily attached to or detached from each other.

Therefore, it is possible to keep the low contact resistance and make attachment and detachment easier.

Further, since the insulating portion 27 is provided to coat the outer surface except for the lower surface 23a of the conductive block 23, short-circuiting caused by a foreign body may be suppressed. Further, when the lower surface 23a of the conductive block 23 is coated to expose the insertion hole 23b, short-circuiting may be further suppressed.

Further, the pressing force of the elastic portion 24 may be minutely adjusted easily by changing a material, a coil shape, or the like thereof.

Further, since the plate surface of the plate-shaped electrode terminal 12 is provided with the through hole 12b and the terminal connection member 20 includes the spherical body 25 fitted to the through hole 12b, the electrode terminal 12 and the terminal connection member 20 are locked to each other by the fitting between the through hole 12b and the spherical body 25. Therefore, the electrode terminal 12 and the terminal connection member 20 may be further reliably prevented from being separated from each other.

### Second Embodiment

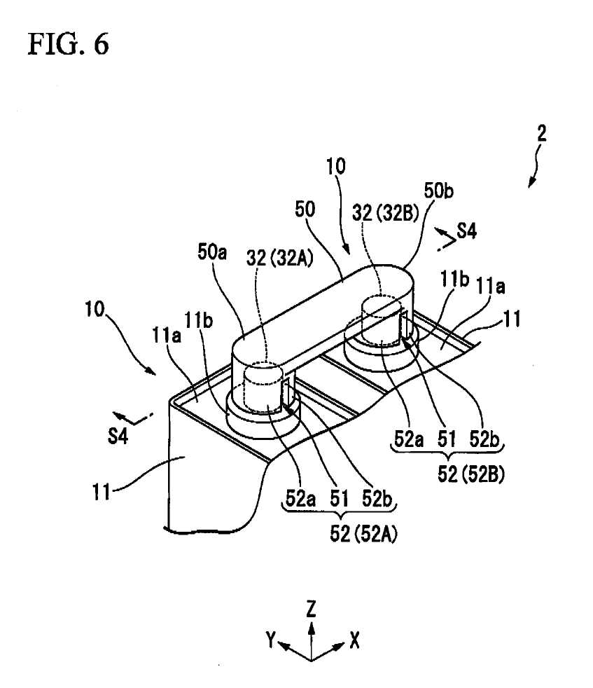

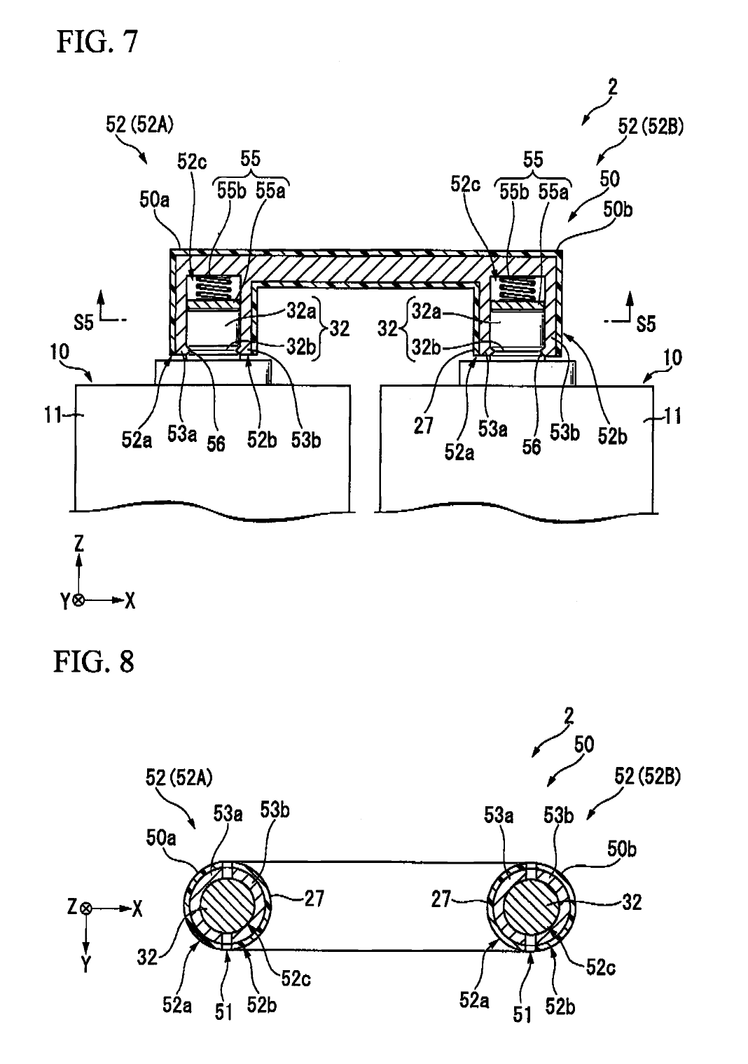

FIG. 6 is a perspective view illustrating a main part of an assembled battery 2 according to a second embodiment of the invention, FIG. 7 is a cross-sectional view taken along the line S4-S4 of FIG. 6, and FIG. 8 is a cross-sectional view taken along the line S5-S5 of FIG. 7. Furthermore, in FIGS. 6 to 8, the same reference numerals are given to the same components as those of FIGS. 1 to 5, and the components will not be repetitively described here.

As shown in FIG. 6, the assembled battery 2 is different from the above-described assembled battery 1 in that a cylindrical electrode terminal 32 is provided compared to the plate-shaped electrode terminal 12 of the electrical cell 10 of the assembled battery 1, and in that a terminal connection member 50 is used instead of the terminal connection member 20.

As shown in FIG. 6, the electrode terminal 32 is formed in a cylindrical shape, and extends to the +Z direction. The electrode terminal 32 includes a circumferential groove (second hollow) 32b that is formed in a circumferential shape at the base end side (−Z direction) of the outer peripheral surface 32a.

As shown in FIG. 7, the terminal connection member 50 includes the conductor 21, a pair of electrode sockets 52 (52A and 52B), and the insulating portion 27.

As shown in FIGS. 6 to 8, the pair of electrode sockets 52 (52A and 52B) protrudes to the −Z direction at both ends 50a and 50b of the terminal connection member 50 in the X direction.

As shown in FIG. 6, the electrode socket 52 (52A and 528) is divided into two parts in the X direction by a dividing portion 51, and includes a split piece (elastic portion) 52a formed in the +X direction and a split piece (elastic portion) 52b formed in the −X direction to face the split piece 52a. As shown in FIG. 7, a pressing mechanism 55 is provided inside an insertion hole 52c defined by the split pieces 52a and 52b.

As shown in FIG. 7, the split pieces 52a and 52b respectively include conductive half cylinders (as opposite conductive walls 23e) 53a and 53b integrally formed with the conductor 21 and protruding from the conductor 21 to the −Z direction. The insulating portion 27 is coated to the outer surfaces of the conductive half cylinders 53a and 53b.

The front-end-side inner peripheral portions of the conductive half cylinders 53a and 53b (in the −Z direction) are respectively provided with inner peripheral claw portions 55 protruding inward in the radial direction.

The split pieces 52a and 52b respectively have elasticity, and are rotatable on the center of the electrode socket 52 at the base ends (in the +Z direction).

As shown in FIG. 8, the cross-section of the insertion hole 52c is formed like a circular shape. The size is substantially equal to the cross-section intersecting the Z direction of the electrode terminal 32. The insertion hole 52c extends in the Z direction as shown in FIG. 7.

The pressing mechanism 55 includes a coil spring 55a of which the base end is fixed to the bottom portion of the insertion hole 52c and a disk 55b which is formed at the front end of the coil spring 55a and formed of copper or the like.

Next, the mounting process of the electrode terminal member 50 with the above-described configuration will be described.

When the electrode terminal member 50 is first attached to the electrical cell 10, the pair of electrode terminals 32 (32A and 32B) is respectively inserted into the insertion holes 52c of the pair of electrode sockets 52 (52A and 52B).

At this time, in the electrode sockets 52 (52A and 52B), the front ends of the split pieces 52a and 52b are displaced to move away from each other about the base ends thereof serving as the rotation centers, so that the opening end of the insertion hole 52c is enlarged. The electrode terminal 32 is inserted into the insertion hole 52c, and is press-inserted into the bottom portion of the insertion hole 52c.

When the electrode terminal 32 is inserted into the insertion hole 52c, the electrode terminal 32 comes into contact with the disk 55b, and the coil spring 55a of the pressing mechanism 55 is contracted to be elastically deformed.

Then, when the electrode terminal 32 is inserted into the insertion hole 52c up to the base end of the electrode terminal 32, as shown in FIG. 7, the circumferential groove 32b and the inner peripheral claw portion 56 are fitted to each other, so that the split pieces 52a and 52b are elastically restored and the diameter of the opening end of the insertion hole 52c is decreased.

In this state, the split pieces 52a and 52b press each other in the X direction, so that the conductive half cylinders 53a and 53b and the electrode terminal 32 are adhered to each other to reduce the contact resistance, and the conductive half cylinders 53a and 53b are restrained by the electrode terminal 32.

Furthermore, the pressing mechanism 55 presses the inner peripheral claw portion 56 to the circumferential groove 32b in the direction, and the disk 55a contacts the conductive half cylinders 53a and 53b. Therefore, conductivity become much better.

On the other hand, when the electrode terminal member 50 is separated from the electrical cell 10, the front ends of the split pieces 52a and 52b are displaced to move away from each other, so that the diameter of the opening end of the insertion hole 52c is enlarged. In this manner, the fitting between the inner peripheral claw portion 56 and the circumferential groove 32b is released.

Then, the electrical cell 10 and the electrode terminal member 50 are relatively displaced in the Z direction to move away from each other, and they are separated from each other.

As described above, the electrode terminal member 50 includes the split piece 52b pressing the electrode terminal 32 and the split piece 52a pressing the electrode terminal 32. Accordingly, it is possible to keep the low contact resistance by adhering the electrode terminal 32 to the conductive half cylinders 53a and 53b through the pressing of the split pieces 52a and 52b. Further, since the electrode terminal 32 and the opposite conductive wall 23e are restrained or released depending on the pressing of the split pieces 52a and 52b, the attachment and detachment between the terminal connection member 50 and the electrode terminal 32 may be easily performed.

Therefore, it is possible to keep the low contact resistance and make attachment and detachment easier.

Further, the electrode socket 52 (52A and 52B) is divided into two parts, and the split pieces 52a and 52b respectively press and restrain the conductive half cylinders 53a and 53b due to the elasticity thereof. Accordingly, since the structure becomes simple, it is possible to decrease the weight or improve maintenance workability.

Further, the split pieces 52a and 52b press each other to respectively adhere the conductive half cylinders 53a and 53b and the electrode terminal 32 to each other, so that contact resistance may be further reduced.

Further, the electrode terminal 32 is formed in a cylindrical shape, the outer peripheral surface 32a is provided with the circumferential groove 32b, and the terminal connection member 50 includes the inner peripheral claw portions 56 protruding from the inner peripheries of the split pieces 52a and 52b toward the electrode terminal 32 and fitted to the circumferential groove 32b, the electrode terminal 32 and the terminal connection member 50 are locked to each other by the fitting between the circumferential groove 32b and the inner peripheral claw portion 56, so that the electrode terminal 32 and the terminal connection member 50 may be further reliably prevented from being separated from each other.

Furthermore, the mounting process and all shapes and combinations of the respective constituting members shown in the above-described embodiments are merely an example, and various modifications based on the design request or the like may be made within the scope of the spirit of the invention.

For example, in the first embodiment, the coil spring is used as the elastic portion 24, but any member having elasticity may be used. For example, a plate spring, natural rubber, or the like may be used.

Further, in the first embodiment, the electrode terminal 12 is provided with the through hole 12b, but may be formed as a hollow in a bottomed cylindrical shape without malting a hole. Further, the electrode terminal 12 may be pressed by at least one of the split pieces 52a and 52b.

Further, in the first embodiment, the pair of electrode terminals 12 (12A and 12B) are connected to each other between two adjacent electrical cells 10. However, the electrical cells may not be essentially adjacent to each other, and the pair of electrode terminals 12 (12A and 12B) may be connected to each other between two electrical cells 10 separated from each other with another electrical cell 10 interposed between them. The same applies to the pair of electrode terminals 32 (32A and 32B) of the above-described second embodiment.

Further, in the first embodiment, the electrode terminal 12 is provided with the through hole 12b, but may be formed as a hollow in a bottomed cylindrical shape without making a hole. Further, the electrode terminal 12 may be pressed by at least one of the split pieces 52a and 52b of the second embodiment.

Further, in the second embodiment, the split pieces 52a and 52b and the conductive half cylinders 53a and 53b press each other with the elasticity thereof. However, a configuration may be adopted in which only one of them has elasticity, only the other thereof has the conductive half cylinder, and one presses the electrode terminal 32 toward the other to be restrained. Further, the electrode terminal 32 may be pressed by the elastic portion 24 of the first embodiment.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An assembled battery comprising:
a plurality of electrical cells that includes a battery body and an electrode terminal protruding from the battery body; and
a terminal connection member that connects a pair of electrode terminals between two of the plurality of electrical cells,
wherein the terminal connection member includes:
a pair of electrode sockets each allowing the electrode terminal to be inserted thereinto, and
a conductor electrically connecting the pair of electrode sockets to each other, and
wherein each electrode socket includes:
an opposite conductive wall extending from the conductor along the electrode terminal and facing the electrode terminal, and
an elastic portion provided at a position facing the opposite conductive wall through the electrode terminal and pressing the electrode terminal to the opposite conductive wall.

2. The assembled battery according to claim 1,
wherein the terminal connection member includes an insulating portion coated on at least a part of an outer surface of the conductor and the opposite conductive wall.

3. The assembled battery according to claim 1,
wherein the elastic portion is formed as a member different from the opposite conductive wall.

4. The assembled battery according to claim 2,
wherein the elastic portion is formed as a member different from the opposite conductive wall.

5. The assembled battery according to claim 3,
wherein the electrode terminal is formed as a flat plate and a first hollow is formed on the flat plate, and
wherein the terminal connection member includes a spherical body provided at the front end of the elastic portion and fitted to the first hollow.

6. The assembled battery according to claim 4,
wherein the electrode terminal is formed as a flat plate and a first hollow formed on the flat plate, and
wherein the terminal connection member includes a spherical body provided at the front end of the elastic portion and fitted to the first hollow.

7. The assembled battery according to claim 1,
wherein the electrode socket is divided into two parts in a direction intersecting the protruding direction of the electrode terminal, at least one of the two parts includes the opposite conductive wall, and at least the other of the two parts is formed to have elasticity and serves as the elastic portion.

8. The assembled battery according to claim 2,
wherein the electrode socket is divided into two parts in a direction intersecting the protruding direction of the electrode terminal, at least one of the two parts includes the opposite conductive wall, and at least the other of the two parts is formed to have elasticity and serves as the elastic portion.

9. The assembled battery according to claim 7,
wherein the electrode terminal is formed like a cylindrical shape and has a second hollow formed on the outer peripheral surface thereof, and
wherein the terminal connection member includes a claw portion protruding from each of the electrode sockets and fitted to the second hollow.

10. The assembled battery according to claim 8,
wherein the electrode terminal is formed like a cylindrical shape and has a second hollow formed on the outer peripheral surface thereof, and
wherein the terminal connection member includes a claw portion protruding from each of the electrode sockets and fitted to the second hollow.
